(19) United States
(12) Patent Application Publication
(10) Pub. No.: US 2003/0157472 A1
(43) Pub. Date: Aug. 21, 2003

(54) Stylus actuated write/erase binders

(75) Inventors: Arthur G. Castillo, Chino Hills, CA (US); Christine K. Hibberd, Irvine, CA (US); Terri L. McKelvaine, Meridian, MS (US); Edward Podosek, Wilbrahan, MA (US)

Correspondence Address: OPPENHEIMER WOLFF & DONNELLY LLP, 38th Floor, 2029 Century Park East, Los Angeles, CA, 90067-3024, US

(73) Assignee: Avery Dennison Corporation

(21) Appl. No.: 10/077,441

(22) Filed: Feb. 15, 2002

(51) Int. Cl. B43L 1/00

(52) U.S. Cl. 434/409

(57) ABSTRACT

A binder, such as a three ring binder, is provided with a read/write panel on the front cover of the binder and with a stylus mounted onto the binder. The read/write panel may be inset into the cover of the binder, or it may constitute substantially the entire front cover of the binder, or it may be inserted into a transparent pocket on the front cover of the binder. The read/write panel includes inner and outer sheets with material between the sheets forming an image upon appliction of a stylus. In one embodiment the inner sheet may be coated with a waxy material; and in another embodiment magnetic particles in a viscous medium are employed. For the magnetic embodiment, the eraser may be of a broad area permanent magnet type which may be brought into engagement with the entire magnetizable panel; or a smaller linear permanently magnetized eraser may be employed. The binder preferably is a full size binder for 8 ½×11 inch or A-4 size sheets of paper.

### FIELD OF THE INVENTION

This invention relates to stylus actuatable write/erase binder assemblies.

### BACKGROUND OF THE INVENTION

Stylus actruated write/erase assemblies are known. For example, one type of widely available stylus actuated write/erase assembly uses an outer translucent plastic sheet and an inner coated plastic sheet which overlay one-another, where an image or writing appears when the stylus applies pressure to the outer sheet; and the image is erased or deleted by raising the outer sheet and separating it from the lower sheet.

Another type of stylus actuated write/erase assembly is embodied in certain types of magnetic toys. These toys characteristically have an upper translucent plastic sheet and a lower plastic sheet bonded together at the edges thereof, with a viscous material, such as a gel or thick fluid between the two sheets, and particulate magnetic material dispersed in the viscous material. A magnetic stylus is provided to write on the assembly by engaging the stylus to the upper surface of the assembly. Magnetic particles are drawn to the upper surface providing a visual image; and a large area magnet or an extended linear magnet is moved across the lower surface of the assembly to erase the image. The assembly may be divided into cells in order to maintain substantially uniform distribution of magnetic particulate material throughout the assembly.

A number of prior art patents disclose specific constructions for write/erase magnetic assembly boards, and these include the following: U.S. Pat. No. 4,643,684; U.S. Pat. No. 4,804,327; U.S. Pat. No. 5,018,979; U.S. Pat. No. 5,057,363; U.S. Pat. No. 5,151,032; U.S. Pat. No. 5,411,398; U.S. Pat. No. 3,426,453; U.S. Pat. No. 5,112,229; U.S. Pat. No. 5,295,837; U.S. Reissue Pat. No. 25,363 and U.S. Pat. No. 3,426,453.

Toys involving the type of magnetic write erase assemblies disclosed in the foregoing patents are available in toy stores. Such toys are provided with magnetic styli and integral mechanical erase arrangements, with the resultant assemblies being in the order of a half inch or more in thickness.

### SUMMARY OF THE INVENTION

In accordance with a broad aspect of the invention a binder, such as a three ring loose-leaf binder is provided with a stylus actuated write/erase panel on at least one cover thereof. The write/erase panel has an outer translucent or transparent sheet, and an inner sheet, and said panel creates an image between the two sheets visible through the outer sheet, as a result of the application of a stylus to the outer sheet. The binder assembly includes arrangements for mounting the stylus onto the binder, and for erasing the image. The invention is particularly applicable to the outer surface of the covers of three ring loose leaf binders containing 8 ½×11 inch or A-4 sheets of paper, widely used by student for taking notes or the like.

In one embodiment the outer front cover of a full size, three ring binder may be provided with a read/write panel including an outer translucent sheet, and an inner sheet coated with wax or the like, so that pressure from a rounded point stylus on the outer sheet will provide a visible indication. The outer sheet may form a pocket with the inner sheet, and arrangements are provided to erase the visible indications by separating the sheets.

In another specific illustrative embodiment of the invention, a three ring type binder for holding papers is provided with a cover which has an exposed magnetic read/write panel which is relatively thin, such as one tenth of an inch (0.10 inch) or less; and secured to the binder are a permanent magnetic stylus, and an extended permanent magnet eraser. The stylus and the extended permanent magnet eraser are removably mounted onto the binder structure so as not to impair the normal capability of the three ring binder.

Various features which may be included in the binder include the following:

1. The extended permanent magnet erasing may be accomplished using a permanent magnet sheet, preferably mounted in the rings of the three ring binder, so that it may be shifted into engagement with the rear of the magnetizable panel for erasing.

2. The permanent magnet eraser may be elongated and may be one inch up to several inches long, and may be mounted on the inside of one of the covers of the binder for easy access.

3. The magnetizable panel may be inserted into the transparent pocket of a binder such as that shown in U.S. Pat. No. 5,857,797.

4. The magnetizable panel may form substantially the entire front cover of the binder.

5. The binder may be of any conventional configuration for holding papers, preferably 8 ½×11 inch sheets or A-4 size sheets, and need not be a conventional three ring binder.

6. The magnetic writing stylus may be mounted on the spine of the binder, or on the inner surface on one of the covers of the binder so that it does not unduly expand the size of the binder.

7. The permanent magnet writing stylus may be structurally combined with a magnetic eraser.

Other objects, features and advantages of the invention will become apparent by consideration of the following detailed description and the accompanying drawings.

### BRIEF DESCRIPTION OF THE DRAWINGS

FIG. 1 is a perspective view of a 3-ring binder illustrating the principles of the invention;

FIG. 2 is a front view of the binder of FIG. 1 showing the read/write erase panel, and the magnetic stylus;

FIG. 3 is a partial cross-sectional view taken along line 3-3 of FIG. 2;

FIG. 4 is a schematic cross-sectional view of one embodiment of a read/write magnetizable panel;

FIG. 5 is a partial cross-sectional view of a stylus showing a small permanent magnet at one end thereof;

FIG. 6 is a perspective view of a broad area permanent magnet which may be used either for erasing by engaging the permanent magnet surface with the backside of the magnetizable panel or for darkening broad areas on the front, writing side of the panel;

FIG. 7 is a cross-section of a linear erasing magnet, with a side view of the erasing magnet of FIG. 7 being shown in FIG. 8;

FIG. 9 shows a simple linear eraser;

FIG. 10 is a cross-sectional view taken along lines 10-10 of FIG. 9;

FIG. 11 is a front view of a binder where the magnetizable panel constitutes most of the front cover of the binder;

FIG. 12 is a partial cross-sectional view of the front cover of the binder taken along lines 12-12 of FIG. 11;

FIG. 13 is a perspective view showing a magnetizable panel being inserted into a transparent pocket in a prior art type binder; and

FIG. 14 is a perspective view of another binder illustrating the principles of the invention in which a broad area erasing magnet is mounted to the rings of the 3-ring binder;

FIG. 15 is a perspective view of an alternative embodiment; and

FIG. 16 shows the erasing of material from the binder.

### DETAILED DESCRIPTION OF THE PREFERRED EMBODIMENTS

While the specification describes particular embodiments of the present invention, those of ordinary skill can devise variations of the present invention without departing from the inventive concept.

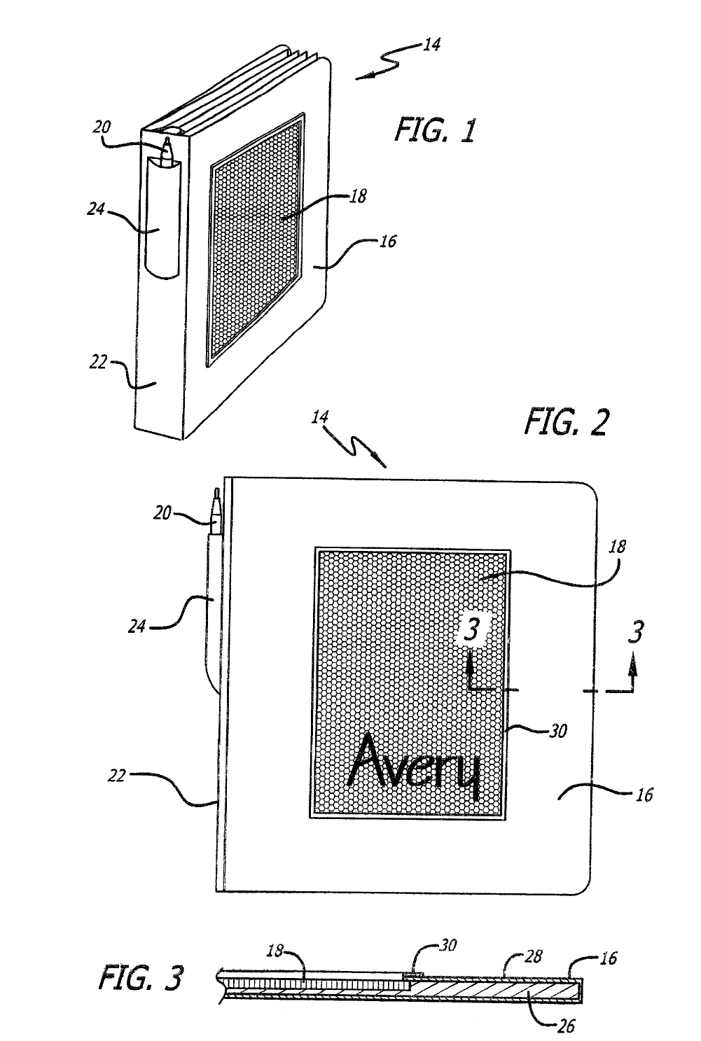

Referring more particularly to the drawings, FIG. 1 is a perspective view of a 3-ring binder 14 having a front cover 16 into which a magnetizable panel 18 has been mounted. A magnetic stylus 20 is mounted on the spine 22 of the binder 14 with an integral pouch 24.

FIG. 2 is a front view of the binder 14, with the reference numerals identifying corresponding parts.

FIG. 3 is a schematic cross-sectional view taken along lines 3-3 of FIG. 2. As shown in FIG. 3 the cover 16 of the binder 14 has a central stiff panel 26 which may be formed of a chip board covered with a thin layer of plastic material 28. The magnetizable panel 18 may be recessed into the cover 26, and may have a thin layer of tape 30 to hold it firmly in place.

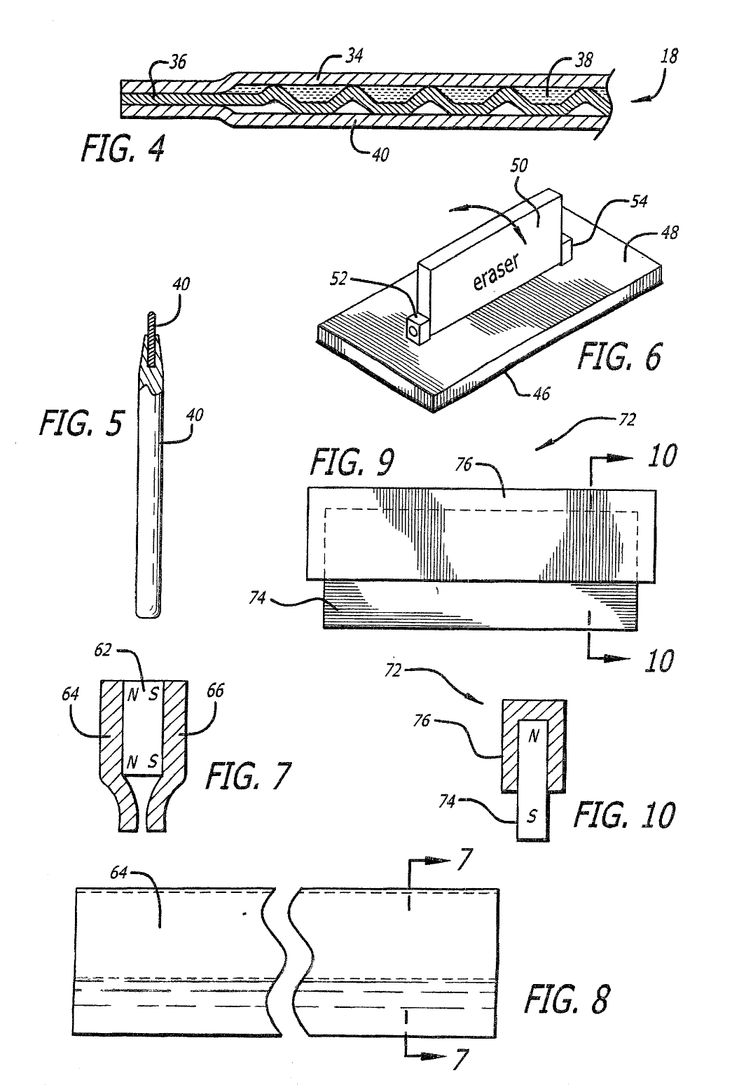

The magnetizable panel 18 may be in any of a number of specific physical configurations, with one panel 18 shown in FIG. 4 corresponding to the panel shown in U.K. Pat. Application 2034640A filed Sep. 14, 1979. The exemplary panel shown in FIG. 4 includes an upper flat transparent or translucent plastic layer 34, and a second layer of plastic material 36 into which a plurality of pockets have been formed. Within the pockets between the layers 34 and 36 is high viscosity or gel like material 38 in which magnetizable material is suspended. With the panel 18 including a large number of spaced pockets, the particulate magnetic material is blocked from drifting down to one edge of the entire panel. Instead, the magnetizable material is distributed across the surface of the panel so that some of the magnetic particulate material is available to respond and to be drawn up against the upper translucent or transparent panel 34 when the stylus is moved into engagement with the upper panel 34. The lower panel 40 is optional and may not be needed when stiffness or semi-rigidity of the two panels 34 and 36 is sufficient. Incidentally, the thickness of the layers in the showing of FIG. 4 has been exaggerated and the total thickness of the panel would normally be about 0.10 inch or less, with each plastic sheet being only a few thousandths of an inch thick.

FIG. 5 shows a stylus 42 which may be formed of plastic material, with a permanent magnet 44, preferably having a rounded tip, extending from one end of the stylus. In order to erase the writing which appears on the magnetizable panel as a result of application of the stylus, a magnetic field is applied to the lower surface of the panel. This may be accomplished by the application of a permanent magnet in the form of a permanently magnetized sheet 46 secured to a plastic sheet 48 to which a handle 50 is pivotally mounted at pivot points 52 and 54. The resultant flat eraser assembly may be mounted on one of the covers of the binder.

In practice, therefore, a stylus such as the stylus 42 engages the upper surface of a magnetizable panel such as the panel 18, and magnetic particles are drawn up into engagement with the inner surface of the translucent panel 34, thereby providing a visual image. When it is desired to erase the image, the permanent magnet eraser unit as shown in FIG. 6, is applied to the lower surface of the panel 18, to pull the magnetic particles away from the upper surface 34, thereby wiping out the image.

Alternative forms of permanent magnet erasers are shown in FIGS. 7, 8, 9 and 10. More specifically, the eraser shown in FIG. 7 includes a permanent magnet 62 with pole pieces of magnetizable material 64 and 66.

FIG. 8 is a side view of the eraser of FIG. 7 with only the pole piece 64 being visible in this showing.

FIG. 9 is a side view of an alternative linearly extending eraser 72 which includes a rectangular elongated permanent magnet 74 and an outer U-shaped plastic layer 76 which covers the upper portion of the magnetic eraser. Incidentally, the cross-sectional view of FIG. 10 is taken along lines 10-10 of FIG. 9.

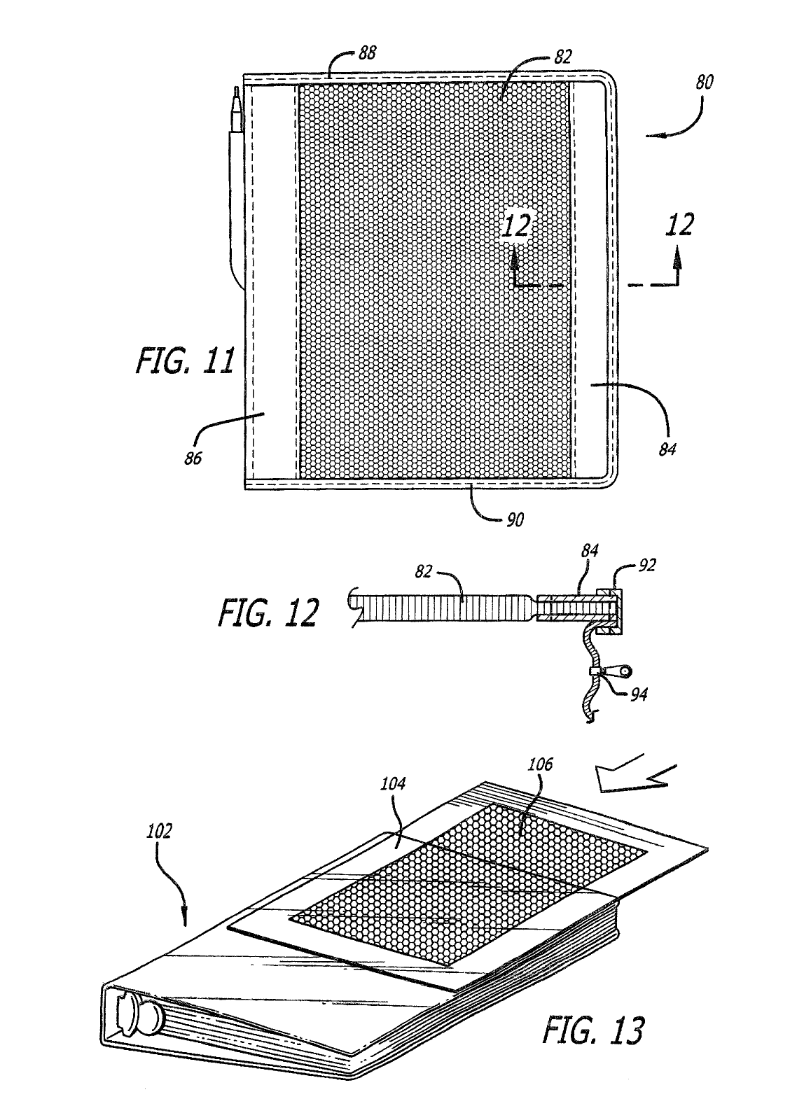

Referring now to FIG. 11 of the drawings, this is a front view of a binder 80 in which the magnetizable panel 82 constitutes virtually all of the front cover of the binder. The outer edges 84, 86, 88 and 90 of the binder are fabric material and they are stitched into the outer edges of the panel 82 where the top and bottom surfaces are bonded together.

FIG. 12 is a cross-sectional view of the top cover and edge treatment of the binder of FIG. 11 taken along lines 12-12 of FIG. 11. In FIG. 12, the magnetizable panel 82 is stitched to the outer cloth binding at reference number 84, with the edge beading of the binder being indicated at reference numeral 92. The zippered closure of the binder 80 is indicated at reference number 94.

FIG. 13 shows a binder 102 of the type shown in U.S. Pat. No. 5,857,797 in which the front cover has a transparent pocket 104 which is intended to receive images such as photographs and the like. In this embodiment, the read/write magnetic panel is mounted in the pocket formed between the transparent window 104 and the main stiff portion of the binder cover.

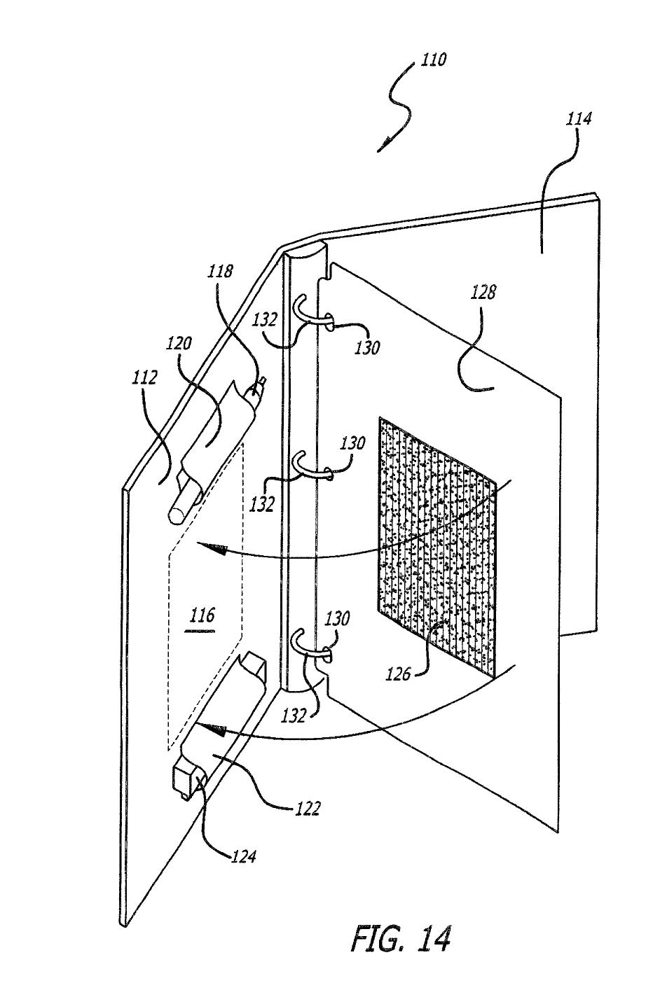

Referring now to FIG. 14 of the drawings, the binder 110 includes a front cover 112, and a rear cover 114. The area 116 which is defined by dashed lines, refers to the location of a magnetizable panel such as the panel 18 as shown in FIG. 1 of the drawings. The stylus 118 is mounted in a stylus holder 120 well above the area 116 where the magnetizable panel is located. Below the area 116 is an additional holder 122 in which the elongated permanent magnet eraser 124 may be mounted. Alternatively, a pen or other conventional writing instruments may be mounted in an appropriately sized pouch 122. A large area permanent magnet 126 is mounted on the flexible plastic panel 128, which in turn is mounted through the apertures 130 to the rings 132 of the binder 110. When the mounting sheet 128 is folded toward the front cover 112, with the permanent magnet material 126 directly overlying the area 116, the permanent magnet material 126 may be pressed forward into engagement with the inner surface of the front cover 112 of the binder, overlying area 116, thereby erasing any image previously written onto the magnetizable panel on the front of the binder. Normally, the panel 128 is spaced somewhat apart from the front cover 112, by the presence of the stylus 118 and the lower pouch 122 on the inner cover 112 of the binder 110. However, the mounting sheet 128 for the permanent magnet eraser 126 is sufficiently flexible that it may be bent slightly permitting engagement of the permanent magnet 126 with the interior surface 116 of the front cover 112 of the binder.

It is noted in passing that the patents cited hereinabove indicate the types of materials which may be employed for the magnetizable binder panel per se. High strength permanent magnet material may be made of known ferrite materials, or any other known high strength magnetic materials.

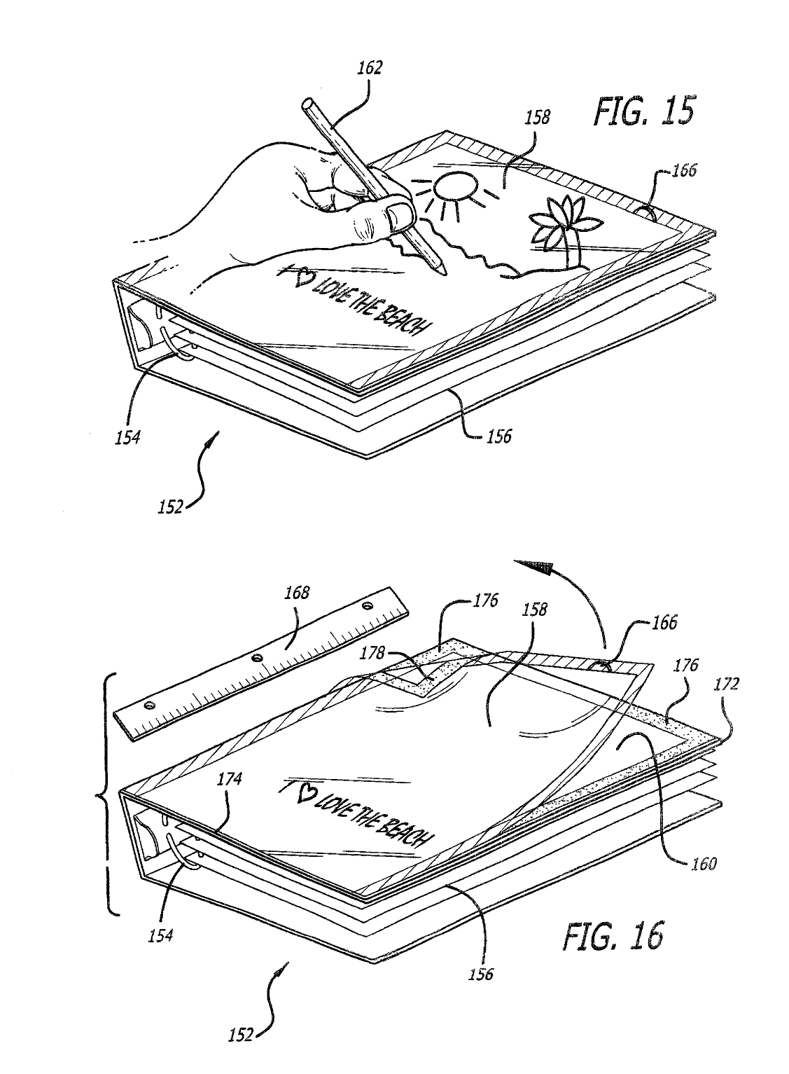

Referring now to FIGS. 15 and 16 of the drawings, they are perspective views showing a three ring binder 152 including a ring mechanism 154 for releasable holding sheets of paper 156 of 8 ½×11 inch or A-4 size. As best shown in FIG. 16, there is a write/erase panel on the front of binder 156, and it is formed of an outer translucent sheet on an inner sheet 160 which is coated across its upper surface with a waxy layer such as paraffin or the like. When the stylus applies pressure to the upper layer 158, an image appears, as a result of the local firm engagement of the upper layer 158 with the waxy surface of the lower layer 160. However, if the two layers 158 and 160 are pulled apart, then the image is erased. If desired, a tab 166 may be provided to raise the upper sheet 158. Alternatively, the user may insert his or her hand, or use an implement such as the ruler 168 to separate the sheets 158 and 160. It may also be noted in passing that the ruler/eraser 168 has three holes to permit easy mounting on the rings of the three ring binder.

With regard to the construction of the binder assembly 152, the inner sheet 160 is permanently mounted to the front cover 172 of the binder. The outer sheet 158 is permanently secured to the front of the binder along the lower edge 174 of sheet 158. Along the other three edges of the sheets 158 and 160, strips of mating hook and loop, or Velcro® type material is employed, as indicated by reference numeral 176 identifying the hook and loop type material on sheet 160, and reference numeral 178 identifying the mating hook and loop type material on the outer sheet 158. When the outer sheet 158 is folded down firmly onto sheet 16 the hook and loop fastening material 176, 178 provides a firm, neat and secure front cover arrangement for the binder assembly.

In the foregoing detailed description several specific embodiments of the invention have been described in some detail. It is to be understood, however, that various changes and modifications may be made by those skilled in the art.

Thus, by way of example and not of limitation, relative to the magnetic embodiment of the invention, different materials for the top and bottom and sheets of the magnetizable panels, as well as different materials for the high viscosity or gel like contents of the panel, and the magnetic particulate material, may be employed, with reference being made to the cited patents. As indicated, the magnetizable panel may constitute the entire front cover of the binder, or may be of a smaller size, occupying only a portion of the area of the front cover of the binder. If desired, the stylus and the eraser may be mounted along the outer edge of the binder so that there is no reduction in the amount of paper or sheets of paper which may be contained within the binder. The binders may be of any of the known types of binders, including those with fairly stiff covers, and those where the covers are quite thin and are semi flexible.

With regard to the construction of the magnetizable panels, although the panels as shown in the present drawings are indicated as being segmented or compartmentalized, this construction is not necessary if the magnetizable material is maintained substantially uniformly distributed across the panel. Preferred magnetizable panels using a micro-encapsulative construction to avoid the need for compartmentalization, are available from a company identified as “China Zhejiang 001 Electronic Group Co. Ltd.” of Zhejiang Province, China.

Concerning other alternatives or variations, it is noted that the magnetic panels may be on either or both the front cover or back cover of the binders. It is noted that the cited prior art references disclose various alternatives including the use of permanently magnetized movable elements in the panel with north and south polarized writing styli; and many other alternatives, any of which may be incorporated into the present binder assemblies. Erasing may be accomplished from the front in some embodiments. It is also noted that when the term “translucent” is used, it includes “transparent” materials. In addition to applicability to common three ring binders the invention is applicable to binders with posts for holding papers and binders where the sheets are held together with spiral, spring like coils, for examples. Concerning the thickness of the magnetic panels, successful binder assemblies have used magnetic panels which are about 80 thousandths (0.080) of an inch thick. More generally, it is desirable to have binders as thin as possible, less than ¼ inch thick and preferably less than one tenth (0.10) inch thick. If desired, a single stylus may be provided with both writing and erasing capabilities, using, for example, an extended magnet on the side thereof, or appropriate north and south poles at different locations on the stylus. The extended linear erasing arrangements may be an inch or more in length, and the width may be one half or less than the length.

Concerning the embodiment of FIGS. 15 and 16, in some cases the sides as well as the bottom of the two sheets 158 and 160 may be permanently secured closed, with the upper edges of the two sheets being open. With this arrangement, erasing or elimination of the image may be accomplished by insertion of the hand, or other object such as the ruler 168 into the pocket formed by the two sheets 158 and 160. In addition, instead of hook and loop type fastening arrangements 176, 178, other holding arrangements, such as pressure sensitive adhesive may be employed. In the case where the bottom and two sides of sheets 158 and 160 are permanently secured together, the upper edges may be permanently open or unsecured, with no additional closure required. In addition, the write/erase panel may be much smaller than the entire front cover of the binder, if desired. Also, the front cover of the binder may be formed of semi-flexible plastic coated with a waxy material, and providing a dual function as the inner sheet of the write/erase panel.

Accordingly, the present invention is not limited precisely to the embodiments shown in the drawings and described in detail hereinabove.

What is claimed is:

1. A binder assembly with a stylus actuatable, write/erase cover comprising:
a binder with front and rear covers and an intermediate spine;
a paper retention construction for holding sheets of 8 ½×11 inch of A-4 paper within said binder mounted at said spine;
said front cover having a substantially flat stylus actuatable write/erase panel mounted on the front side thereof;
said write/erase panel having inner and outer sheets, said outer sheet being translucent, a stylus for application to said outer sheet to write on or create an image on said write/erase panel;
said panel creating an image between said two sheets and visible through said outer sheet as a result of the application of said stylus;
said binder assembly including erasing arrangements for said write/erase panel to erase any image appearing on said panel;
said binder having retaining arrangements for mounting said stylus onto said binder; and
said binder assembly also including arrangements for firmly securing the entire write/erase panel to the front cover of the binder, for viewing from the front of said binder.

2. A binder assembly as defined in claim 1, wherein said stylus is mounted on said spine.

3. A binder assembly as defined in claim 1, wherein said read/write panel forms the greater part of said front cover.

4. A binder assembly as defined in claim 1, wherein said binder assembly includes a translucent pocket on the front cover of said binder.

5. A binder assembly as defined in claim 1 wherein said write/erase panel is pressure responsive, whereby pressure from said stylus will force said inner and outer sheets together to form an image.

6. A binder assembly as defined in claim 5, wherein said erasing arrangements include a mounting configuration for said outer sheet to permit separation of said outer sheet from said inner sheet.

7. A binder assembly as defined in claim 1, wherein said assembly includes a front pocket with a translucent outer sheet.

8. A binder assembly as defined in claim 1, wherein said write/erase panel includes viscous material between said sheets, particulate magnetic material dispersed in said viscous material; and wherein said stylus includes a permanent magnet.

9. A binder assembly with a stylus actuatable, write/erase cover comprising:
a binder with front and rear covers;
a paper retention construction for holding sheets of 8 ½×11 inch or A-4 size paper within said binder, mounted at said spine;
said front cover having a substantially flat stylus actuatable write/erase panel mounted on the front side thereof;
said write/erase panel having inner and outer sheets, said outer sheet being translucent,
a stylus for application to said outer sheet to write on or create an image on said write/erase panel;
said panel creating an image between said two sheets and visible through said outer sheet as a result of the application of said stylus;
said binder assembly including erasing arrangements for said write/erase panel to erase any image appearing on said panel;
said binder having retaining arrangements for mounting said stylus onto said binder; and
said binder assembly also including arrangements for firmly securing the entire write/erase panel to the front cover of the binder, for viewing from the front of said binder.

10. A binder assembly with a stylus actuatable, write/erase cover comprising:
a binder with front and rear covers and an intermediate spine;
a paper retention construction for holding sheets of 8 ½×11 inch of A-4 paper within said binder mounted at said spine;
said front cover having a substantially flat stylus actuatable write/erase panel mounted on the front side thereof;
said write/erase panel having inner and outer sheets, with a waxy coating on at least one of said sheets facing the other sheet;
said outer sheet being translucent,
a stylus for application to said outer sheet to write on or create an image on said write/erase panel;
said panel creating an image between said two sheets and visible through said outer sheet as a result of the application of pressure by said stylus to said outer sheet;
said binder assembly including erasing arrangements for said write/erase panel to erase any image appearing on said panel;
said binder having retaining arrangements for mounting said stylus onto said binder; and
said binder assembly also including arrangements for firmly securing the entire write/erase panel to the front cover of the binder, for viewing from the front of said binder.

11. A binder assembly with a stylus actuatable, write/erase cover comprising:
a binder with front and rear covers and an intermediate spine;
a paper retention construction for holding sheets of paper within said binder mounted at said spine;
at least one of said covers having a substantially flat stylus actuatable write/erase panel mounted thereon;
said write/erase panel having inner and outer sheets, said outer sheet being translucent,
a stylus for application to said outer sheet to write on or create an image on said write/erase panel;
said panel creating an image between said two sheets and visible through said outer sheet as a result of the application of said stylus;
said binder assembly including erasing arrangements for said write/erase panel to erase any image appearing on said outer sheet; and
said binder having retaining arrangements for mounting said stylus onto said binder.

12. A binder assembly comprising:
a front cover;
a rear cover hingedly coupled to said front cover;
a paper retention construction for holding papers within said binder;
a magnetizable panel forming at least part of one of said covers;
a magnetic stylus for writing on or forming an image on said panel; and
a magnetic eraser for application to said magnetizable panel to clear any writing or image on said panel.

13. A binder assembly as defined in claim 12, wherein said magnetizable panel forms the greater part of said front cover.

14. A binder as defined in claim 12, wherein said panel is mounted in a transparent pocket on the front cover of said binder.

15. A binder as defined in claim 12, wherein said magnetic eraser is substantially the same size as said magnetizable panel.

16. A binder as defined in claim 15, wherein said eraser is mounted on said paper retention construction for movement toward and away from said magnetizable panel.

17. A binder as defined in claim 12, wherein said magnetizable panel is exposed both to the front of said binder, and at the inner surface of the front cover of said binder.

18. A binder as defined in claim 12, wherein both said magnetic stylus and said magnetic eraser are mounted on the inner surface of said front cover.

19. A binder as defined in claim 12, wherein said eraser includes a plate of permanently magnetizable material.

20. A binder as defined in claim 12, wherein said eraser includes a permanent magnet and overlying plastic material for gripping said eraser.

21. A binder assembly as defined in claim 12, wherein the magnetizable panel is less than one tenth (0.10) of an inch thick.

22. A binder assembly comprising:
a front cover;
a rear cover hingedly coupled to said front cover;
a paper retention construction for holding papers within said binder;
a magnetizable panel forming at least part of one of said covers;
a magnetic stylus for writing on or forming an image on said panel; and
said assembly including magnetic arrangements for application to said magnetizable panel to clear any writing or image on said panel.
